(19) United States
(12) Patent Application Publication
(10) Pub. No.: US 2026/0322298 A1
(43) Pub. Date: Oct. 15, 2026

(54) SENSORLESS CONTROL SYSTEM AND METHOD FOR AN ELECTRIC MOTOR

(71) Applicant: ASCEND KUNPENG SMART AVIATION (GUANGDONG) HOLDING CO., LTD., Zhongshan City (CN)

(72) Inventor: YEE MIN TEE, Klang City (MY)

(73) Assignee: ASCEND KUNPENG SMART AVIATION (GUANGDONG) HOLDING CO., LTD., Zhongshan City (CN)

(21) Appl. No.: 19/643,788

(22) Filed: Apr. 9, 2026

(30) Foreign Application Priority Data
Apr. 9, 2025 (CN) 202510441894.6

(51) Int. Cl. H02P 21/18; H02P 21/13; H02P 21/22

(52) U.S. Cl. CPC H02P 21/18; H02P 21/13; H02P 21/22

(57) ABSTRACT

This invention provides a sensorless observer for an electric motor, a method and an unmanned aerial vehicle (UAV). The system comprises a controller, as well as a current acquisition module, a voltage acquisition module, a LPF and a HPF that are respectively electrically connected to the controller, with the cutoff frequencies of the LPF and the HPF being equal. The system of this invention is capable of operating over a wide speed range, achieving high precision and robustness. It can obtain fast convergence within an extremely short time and support near-zero-speed closed-loop control. Additionally, the system is applicable in a wide speed range and has a simple design: it eliminates the need to adjust the PI controller or sliding mode controller inside the observer, requiring only the setting of the filter cutoff frequency and thus eliminating the parameter setting process.

### CROSS REFERENCE TO RELATED APPLICATIONS

The present invention is 35 U.S.C. § 119 benefit of earlier filing dates; rights of priority of Chinese Applications No. 202510441894.6 filed on Apr. 9, 2025, the disclosure of which is incorporated by reference herein.

### BACKGROUND OF THE PRESENT INVENTION

### Field of the Present Invention

The present disclosure relates generally to electric motors, and more particularly to a sensorless control system and method for an electric motor.

### Description of Related Art

In the field of motor control, a sensorless observer (algorithm) for calculating position angle θ and velocity can significantly improve the accuracy, efficiency, and dynamic response performance of motor control in sensorless applications. Currently, common algorithms for calculating angle θ and velocity mainly include: sliding mode observer, nonlinear flux observer and the like. Although these algorithms have achieved some success in position calculation, they still have many shortcomings in practical applications.

The Sliding Mode Observers (SMO) belong to a class of non-linear observers used to estimate the internal state of an observable system based on the measured input and output. The SMO is used to estimate the back-EMFs of the PMSM. The major advantage of using SMO over a conventional linear back-EMF based rotor position and speed estimation is its robustness in the presence of unknown signals and uncertainties. The SMO estimates the BEMFs using a PMSM system model, voltage, and current vector input. However, the SMO has disadvantages of chattering phenomena because of back-and-forth jitter on the sliding mode gain, affecting an observation accuracy. Conventional sliding film observers generate large amounts of high-frequency switching ripples even after filtering, they cannot commute quickly at high speeds due to the nature of the observer itself. Further, the SMO has a poor low speed performance because the back EMF has a small amplitude at low motor speed, resulting in poor observation performance.

The nonlinear flux observer is an active position sensorless method that has been proven in practice. The nonlinear flux observer based on a nonlinear model of the electric motor can estimate the flux based on the nonlinear observer expressions; it has good low-speed performance and has good adaptability for various motor types and operating conditions. However, the nonlinear flux observer has poor robustness because the flux observation does not consider a saliency of the electric motor, making it sensitive to parameter changes; and having computational complexity because the design and implementation of the nonlinear observer are complex, requiring significant computation and high hardware resources.

### SUMMARY OF THE PRESENT INVENTION

It is an objective of some embodiments to provide a sensorless control system and method for an electric motor w, estimating the position of the rotor and controlling the electric motor.

To achieve such objective, the present disclosure provides a sensorless control system for an electric motor, comprising:
a current acquisition module, used for measuring stator currents of the electric motor in real time;
a voltage acquisition module, used for measuring stator voltages of the electric motor; and
a controller, comprising:
a voltage model, for obtaining a first stator flux

$${ψ}_{A}^{VM}$$

using a voltage-model algorithm based on an a-axis stator current i_{α}, a β-axis stator current i_{β}, an α-axis stator voltage V_{α}, a β-axis stator voltage V_{β} and a stator resistance Rs;
a current model, for defining a second stator flux

$${ψ}_{A}^{CM}$$

using a current-model algorithm based on a rotor angle θ, a d-axis inductance L_{d}, a q-axis inductance L_{q}, a d-axis current i_{d}, a q-axis current i_{q}, and a permanent magnet flux ψ_{f} generated by permanent magnets in the electric motor;
a low-pass filter (LPF), connected to the current-mode model and used for filtering the second stator flux

$${ψ}_{A}^{CM}$$

of the current-mode model;
a high-pass filter (HPF), connected to the voltage-mode model and used for filtering the first stator flux

$${ψ}_{A}^{VM}$$

of the voltage-mode model; and
a hybrid observer, which is constructed by combining the voltage model and the current model, and is used for estimating an active αβ-axis stator flux ψ_{A}, wherein a pair of the LPF and the HPF with equal cutoff frequencies are used to filter the first and second stator fluxes of the voltage model and the current model, respectively; the filtered first and second stator fluxes are summed to obtain the active αβ-axis stator flux ψ_{A}.

The controller performing steps of:
implementing the voltage-model algorithm and obtaining the first stator flux

$${ψ}_{A}^{VM}$$

of the voltage model;
implementing the current-model algorithm and obtaining the second stator flux

$${ψ}_{A}^{CM}$$

of the current model;
outputting

$${ψ}_{A}^{VM}$$

of the voltage model to the HPF for filtering, and outputting

$${ψ}_{A}^{CM}$$

of the current model to the LPF for filtering;
constructing the hybrid observer by combining a voltage-model output passed through the HPF and a current-flux-model output passed through the LPF, and estimating the active αβ-axis stator flux ψ_{A} of the hybrid observer using the filtered

$${ψ}_{A}^{VM}$$

and

$${ψ}_{A}^{CM} ;$$

converting the active αβ-axis stator flux ψA into an active rotor flux; and
estimating the rotor angle by applying an arctangent calculation to components of the active rotor flux.

In other aspect, the present invention provides an unmanned aerial vehicle (UAV) comprising the aforementioned the sensorless control system for an electric motor.

The sensorless control system and method of the present invention, uses a hybrid observer that combines a current model filtered by a low-pass filter (LPF) and a voltage model filtered by a high-pass filter (HPF), thus possess advantages of both the current model and the voltage model, such as:

### 1. Wide Speed Range Operation:

obtaining a full-range operation from zero speed to high speed, adapted to various flight conditions (such as hovering, high-speed flight, rapid maneuvering) of UAVs, and eliminating the need for PI parameter setting due to the LPF and HPF;

### 2. High Precision and Robustness:

wherein, when the electric motor frequency is below the cutoff frequency, the current model avoids an integral error of the voltage model and the inverter nonlinearity problem, thus improving the observation accuracy; and when the electric motor frequency is higher than the cutoff frequency, the voltage model ensures the stability and dynamic performance of the observer;

### 3. Fast Convergence:

wherein the sensorless hybrid observer of this invention can converge rapidly in a very short time, supports closed-loop control at near-zero speed, improves the stability of UAV hovering and take-off and landing at low speed, and obtains high-precision rotor position estimation for the electric motor;

### 4. Wide Applicability:

wherein the sensorless hybrid observer of this invention defines an active flux which makes the system applicable to various motor types, including a surface-mounted permanent magnets synchronous motor (SPMSM) and an interior permanent magnet synchronous motor (IPMSM), the sensorless hybrid observer of this invention has strong robustness to changes in motor parameters and external disturbances;

### 5. Simplified Design:

the active flux and the hybrid observer structure are introduced, simplifying the design and implementation of a flux observer (sensorless hybrid observer), solving the salient polarity problem caused by the different magnetic permeabilities of permanent magnets and core materials and applicable to SPMSM and IPMSM; the design of the active flux of the hybrid observer combines the current model (with excellent performance at low speeds) and the voltage model (with good stability at high speeds) to obtain high-precision flux observation in full speed range;

### 6. Filter Design:

low-pass and high-pass filters with equal cutoff frequencies are used to process the fluxes of the current model and the voltage model respectively, the final active flux along the α- and β-axes in the stationary αβ reference frame is obtained by summing the filtered flux of the current model and the filtered flux of the voltage model, improving observation precision and dynamic response; this sensorless observer of the present invention eliminates the need to adjust the proportional-integral (PI) controller or sliding-mode controller (SMC) within the existing observers; the sensorless observer of the present invention only require setting the filter cutoff frequency, thus avoiding the parameter setting process for traditional observers;

### 7. Motor Rotor Position Estimation:

wherein the electric motor rotor angle is calculated using an arctangent calculation method, obtaining high-precision position estimation, suitable for sensorless control scenarios;
   8. Performance of the Hybrid Observer of the Present Invention is that:
at low speeds, the current model dominates, improving observation precision and robustness; and
at high speeds, the voltage model dominates, ensuring the stability of the observer.

### BRIEF DESCRIPTION OF DRAWINGS

FIG. 1 is a functional block diagram of a sensorless (without a position sensor) control system for an electric motor in accordance with an embodiment of the present invention;

FIG. 2 presents the experimental results of the sensorless control system, comparing the true values of the motor angle with the estimated angle calculated by the sensorless hybrid observer (sensorless control system) according to the embodiment of the present invention; and

FIG. 3 is a flowchart of a sensorless control method for an electric motor in accordance with the embodiment of the present invention.

### DETAILED DESCRIPTION OF THE PRESENT INVENTION

To make the objectives, technical solutions, and beneficial effects of the present invention clearer, the present invention will be further described in detail below with reference to the accompanying drawings and embodiments. It should be understood that the specific embodiments described herein are merely illustrative of the present invention and are not intended to limit the present invention.

To illustrate the technical solutions of the present invention, specific embodiments will be described below.

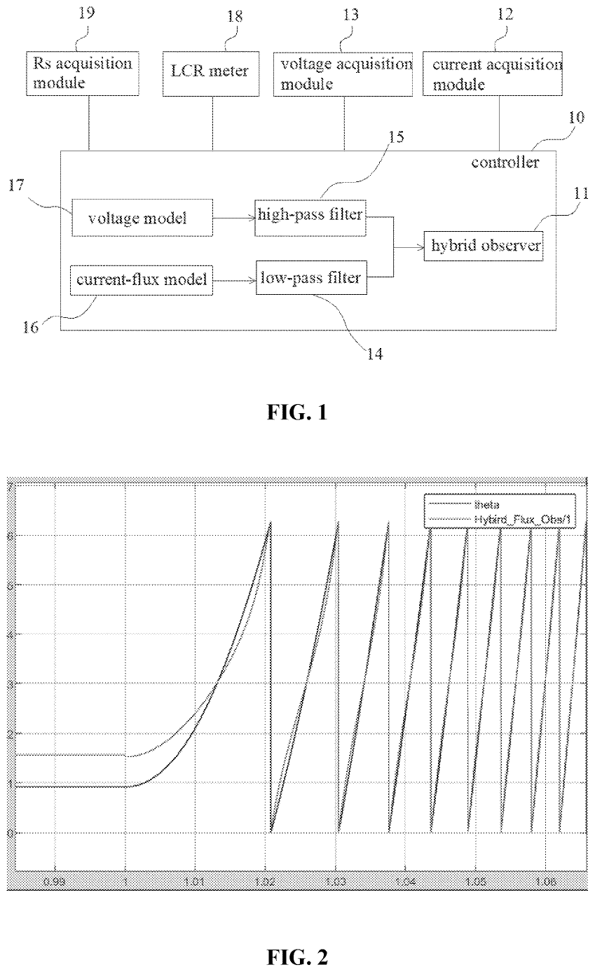

Referring to FIG. 1, a sensorless control system for an electric motor provided in this embodiment of the present invention includes a controller 10 of the electric motor, and a current acquisition module 12, a voltage acquisition module 13, an LCR 18, and an Rs acquisition module 19 electrically connected to the controller 10. The controller 10 comprises a hybrid observer 11, which is constructed by fusing a voltage model 17 which is connected with a high-pass filter (HPF) 15 and a current model 16 which is connected with a low-pass filter (LPF) 14. The cutoff frequency of the low-pass filter 14 and the cutoff frequency of the high-pass filter 15 are equal, forming a pair of LPF and HPF with equal cutoff frequency.

The current acquisition module 12 is used to acquire stator currents of the electric motor in real time, including the following α-axis stator current i_{α}, β-axis stator current i_{β}, d-axis (direct-axis) current d-axis current i_{d}, and q-axis (quadrature-axis) current i_{q}.

The voltage acquisition module 13 is used to acquire stator voltages of the electric motor, including the following α-axis stator potential Va and β-axis stator potential V_{β}.

The HPF 15 is used to filter (or modify) a first stator flux ψ_{A}^{VM} of the voltage model of the electric motor.

The LPF 14 is used to filter (or modify) a second stator flux ψ_{A}^{CM} of the current model of the electric motor.

The LCR meter 18 is used to measure stator inductances, such as the d-axis inductance L_{d} and the q-axis inductance L_{q}, etc. When using the LCR meter 18, a zeroing operation is performed using a short-circuit calibration fixture (having short-circuit test terminals) to eliminate the impact of parasitic parameters, the automatic measurement function is activated, and the LCR meter 18 is connected to the electric motor stator to be measured. The LCR meter 18 displays the inductance value. An LCR meter 18 is an electronic test instrument used to measure inductance (L), capacitance (C), and resistance (R).

The Rs acquisition module 19 is used to obtain stator resistance Rs, including: using a DC power supply to supply a short-circuit current to the stator, measuring a corresponding voltage and current of the stator, and calculating the ratio of the measured voltage to the measured current to obtain the resistance value.

The controller 10 performs a control method for the electric motor comprising following steps of S101 to S106.

S101, obtaining a first stator flux ψ_{A}^{VM} of the voltage model of the electric motor.

In this embodiment of the present invention, the first stator flux

$${ψ}_{A}^{VM}$$

of the voltage model is calculated using the voltage-model algorithm according to Expression (1):

$$\{ \begin{matrix}ψ α = \int ( {V}_{α} - {i}_{α} {R}_{s} ) d t \\ ψ β = \int ( {V}_{β} - {i}_{β} {R}_{s} ) d t\end{matrix} \qquad ( 1 )$$

wherein, ψ_{α} represents an α-axis stator flux of the voltage model in a stationary αβ reference frame, ψ_{β} represents an β-axis stator flux of the voltage model in the stationary αβ reference frame, V_{α} represents an α-axis stator potential/voltage of the electric motor, V_{β} represents a β-axis stator potential/voltage of the electric motor, i_{α} represents an α-axis stator current of the electric motor, i_{β} represents a β-axis stator current of the electric motor, Rₛ represents the stator resistance, and “dt” denotes an integral over time. The voltage model relies on real-time sampling of potential (voltage) and current without requiring speed feedback, but is subject to integral drift issues such as initial value errors and low-frequency integral saturation. The stator resistance Rₛ is acquired by the Rₛ acquisition module 19, the stator currents i_{α} and i_{β} are measured by the current acquisition module 12, and the stator voltages V_{α} and V_{β} are measured by the voltage acquisition module 13.

S102, obtaining a second stator flux

$${ψ}_{A}^{CM}$$

of the current model of the electric motor.

In this embodiment of the present invention, the second stator flux ψ_{A}^{CM} of the current model is calculated using the current-model algorithm according to Expression (2):

$$[ \begin{matrix}{ψ}_{α} \\ {ψ}_{β}\end{matrix} ] = [ \begin{matrix}cos θ & - sin θ \\ sin θ & cos θ\end{matrix} ] \cdot [ \begin{matrix}{L}_{d} {i}_{d} + {ψ}_{f} \\ {L}_{q} {i}_{q}\end{matrix} ] \qquad ( 2 )$$

wherein ψ_{α} represents the α-axis stator flux of the current model in the stationary αβ reference frame, ψ_{β} represents the β-axis stator flux of the current model in the stationary αβ reference frame, θ is the rotor angle (which represents a rotor position), L_{d} represents the d-axis inductance, L_{q} represents the q-axis inductance, i_{d} represents the d-axis current, i_{q} represents the q-axis current, and ψ_{f} represents the flux generated by the permanent magnets in the electric motor. The current model is sensitive to motor parameters and has good dynamic response, and is often used in low-speed applications. The stator inductances L_{d} and L_{q} are acquired by the LCR meter 18, the stator currents i_{d} and i_{q} are measured by the current acquisition module 12. Wherein the rotor angle (rotor position) θ, i.e., the current rotor angle, is computed by an arctangent function. Expression (2) introduces the rotor angle θ to be calculated in this invention.

The permanent magnet flux ψ_{f} is determined by connecting oscilloscope channels to any two phases of the electric motor and performing a no-load back-electromotive force (EMF) test.

S103, defining an active flux and constructing a hybrid observer by combining the voltage model and the current model for eliminating a salient pole effect of the motor.

Wherein, in practical motor applications, the air gap permeability of the motor=the permeability of the permanent magnet<the permeability of the core material. This will lead to uneven distribution of the motor's magnetic field. SPMSM (surface permanent magnet synchronous motor) will also produce salient polarity with unequal d-q axis inductance. With salient polarity, the motor's flux will not only include the inherent permanent magnet flux ψ_{f}, but also include the part(L_{d}-L_{q})i_{d} generated by the d-axis current. Introducing the concept of active flux

$${φ}_{d}^{a} ,$$

and a more accurate expression (as shown in Expression (3)) is provided to describe the active flux

$${φ}_{d}^{a} ,$$

improving control performance.
defining an active flux φ_{d}^{a} as Expression (3):

$$\begin{matrix}{φ}_{d}^{a} = {φ}_{f} & for SPMSM ( {L}_{d} = {L}_{q} ) \\ {φ}_{d}^{a} = {φ}_{f} + ( {L}_{d} - {L}_{q} ) {i}_{d} & for IPMSM ( {L}_{d} < {L}_{q} )\end{matrix} \qquad ( 3 )$$

wherein, the active flux φ_{d}^{a} represents the total d-axis flux; φ_{f} represents the permanent magnet flux which is flux constant, L_{d} represents the d-axis inductance, L_{q} represents the q-axis inductance, and the d-axis current i_{d} is used for a correction to the flux.

For non-salient pole motors (such as SPMSMs) and salient pole motors (such as IPMSMs), the active flux

$${φ}_{d}^{a}$$

is introduced to solve the salient pole problem caused by the difference in magnetic permeability between permanent magnets and core materials. The definition of active flux simplifies the design of the flux hybrid observer, making them applicable to various motor types. For a SPMSM (surface permanent magnet synchronous motor), since the d-axis inductance L_{d} is equal to the q-axis inductance L_{q}, then there is no saliency effect, the total d-axis flux

$${φ}_{d}^{a}$$

is only determined by the permanent magnet flux ψ_{f} itself, and the d-axis current i_{d} will not exert an additional effect on the flux through the inductance difference, herein, the expression (2) can be directly applied to calculate the stator flux

$${ψ}_{A}^{CM}$$

of the current model. For an IPMSM (interior permanent magnet synchronous motor), since the d-axis inductance L_{d} is smaller than the q-axis inductance L_{q}, then the saliency effect exists; therefore, the total d-axis flux φ_{d}^{a}, besides φ_{f} (the inherent flux of the permanent magnets), also needs to consider the difference between the d-axis inductance L_{d} and the q-axis inductance L_{q} applies a modulation effect on the d-axis current i_{d}, herein, use

$${φ}_{d}^{a} ,$$

i.e. use ψ_{f}+(L_{d}−L_{q})i_{d} to replace the “ψ_{f}” in the expression (2). The active flux

$${φ}_{d}^{a}$$

is used to replace the permanent magnet flux ψ_{f} in expression (2), thereby introducing the active flux for constructing the hybrid observer. When the motor has salient polarity (Ld<Lq), use the active flux φ_{d}^{a} replaces the original d-axis flux.

The above embodiment describes use of an active-flux concept to simplify rotor-flux modeling and observer design for interior permanent magnet synchronous motors (IPMSMs), and to enable high-accuracy current-model based estimation. In this embodiment, an active flux φ_{d}^{a} is defined and introduced to replace the conventional d-axis permanent-magnet flux linkage (ψ_{f}) in the motor current model. The active flux aggregates the permanent-magnet flux linkage and the flux contribution due to saliency (the inductance difference Ld−Lq) so that the IPMSM is mathematically represented as an equivalent surface-mounted PMSM (SPMSM) having an active inductance Lq. Use of φ_{d}^{a} removes cross-coupling terms caused by saliency and significantly simplifies observer and estimator design for sensorless control of IPMSMs. The active flux φ_{d}^{a} is defined as: φ_{d}^{a}=φ_{f}+(L_{d}−L_{q})i_{d} (see expression (3) of the disclosure). Here φ_{f} is the permanent-magnet flux, L_{d} and L_{q} are d-axis and q-axis stator inductances respectively, and i_{d} is the d-axis stator current. By absorbing the saliency-induced flux term (L_{d}−L_{q})i_{d} into φ_{d}^{a}, the motor model expressed in the dq frame no longer contains the explicit cross-coupling term arising from inductance difference. The current model originally presented as expression (2), which was derived under an SPMSM assumption using a constant ψ_{f}, is adapted as follows: prior to using the current model for estimation, compute φ_{d}^{a} according to expression (3). Substitute φ_{d}^{a} for ψ_{f} in expression (2). This substitution aligns the current model with the IPMSM physical behavior while retaining the simpler mathematical structure of the SPMSM model.

Implementation expression (3) to expression (2) include steps of:
a. measuring or computing d-axis current i_{d} and known motor parameters L_{d} and L_{q};
b. computing φ_{d}^{a}=ψ_{f}+(L_{d}−L_{q})i_{d} (expression (3));
c. replacing the constant ψ_{f} in the current model (expression (2)) with φ_{d}^{a};
d. using the modified current model for observer design, sensorless control, or rotor angle estimation, benefiting from reduced cross coupling and simplified dynamics equivalent to an L_{q} inductance motor.

Practical considerations compute φ_{d}^{a} prior to any flux based calculations or observer operations, i.e., φ_{d}^{a} must be evaluated and substituted into the current model before commencing magnetic flux computations or using the current model for estimation.

Advantages of active flux φ_{d}^{a} are: (i) converting an IPMSM model to an equivalent SPMSM form for modeling convenience, (ii) eliminating explicit saliency cross coupling in the current model, and (iii) enabling simpler, higher accuracy current model observers for sensorless control of IPMSMs.

Combining Expressions (1) to (3), substituting Expression (3) into Expression (2) yields the effect stator flux ψ_{A}^{CM} of the current model, constructing the hybrid observer and calculating an active αβ-axis stator flux ψ_{A} observed by the hybrid observer according to expressions (4):

$${ψ}_{A} = {\underbrace{\frac{{k}_{p} s + {k}_{1}}{{s}^{2} + {k}_{p} s + {k}_{1}}}}_{LPF} {ψ}_{A}^{CM} + {\underbrace{\frac{{s}^{2}}{{s}^{2} + {k}_{p} s + {k}_{1}}}}_{HPF} {ψ}_{A}^{VM} \qquad ( 4 )$$

wherein “s” represents the frequency in the Laplace transform domain; kₚ and kᵢ are the filter parameters that determine the filtering characteristics, with their specific values depending on the desired cutoff frequency of the filters. The first stator flux

$${ψ}_{A}^{VM}$$

produced by the voltage model 17 is passed through the HPF 15, the active stator flux

$${ψ}_{A}^{CM}$$

produced by the current model 16 is passed through the LPF 14, and the filtered outputs

$${ψ}_{A}^{VM}$$

and

$${ψ}_{A}^{CM}$$

tire summed to yield the observed active αβ-axis stator flux ψ_{A} along the α- and β-axes in the stationary αβ reference frame.

Wherein, the total flux (active αβ-axis stator flux) ψ_{A} is obtained by combining the first stator flux of the voltage model and the second stator flux of the current model. The calculated values of ψ_{A} here are the stator fluxes expressed in voltage and current models s. The true stator flux is a sum of a magnetic resistance flux, a rotor flux, and a stator q-axis self-inductance flux. Subtracting the stator q-axis self-inductance flux from the true stator flux gives the result including angular information. Because the concept of active flux φ_{d}^{a} is introduced, the magnetic resistance flux can actually be omitted.

Step S104, setting kᵢ=0, wherein the HPF 15 and the LPF 14 are set as a pair of first-order HPF and the LPF with an equal cutoff frequency, then the second-order stator flux ψ_{A} of Expression (4) is reduced to a first order active stator flux ψ_{A} as set forth in Expression (5):

$${ψ}_{A} = \frac{{k}_{p}}{s + {k}_{p}} {ψ}_{A}^{CM} + \frac{s}{s + {k}_{p}} {ψ}_{A}^{VM} \qquad ( 5 )$$

wherein the pair of HPF and the LPF with an equal cutoff frequency of 1/kₚ. In other words, the observed active stator flux ψ_{A} of the hybrid observer as set forth in Expression (4) can be simplified only by adjusting the cutoff frequency.

S105, converting the observed active stator flux ψ_{A}(φ_{A}^{CM}, φ_{A}^{VM}) into an active rotor flux (ψ_{αr}, ψ_{βr}) of an expression (6):

$$[ \begin{matrix}{ψ}_{α r} \\ {ψ}_{β r}\end{matrix} ] = [ \begin{matrix}{ψ}_{α} \\ {ψ}_{β}\end{matrix} ] - [ \begin{matrix}{L}_{q} \times {i}_{α} \\ {L}_{q} \times {i}_{β}\end{matrix} ] \qquad ( 6 )$$

wherein, ψ_{α} represents the α-axis stator flux of the hybrid observer in the stationary αβ reference frame, ψ_{β} represents the active β-axis stator flux of the hybrid observer in the stationary αβ reference frame, ψ_{α}/ψ_{β} represent components of the sum of the voltage flux and current flux after high-pass and low-pass filtering, i.e. the second or first order active stator flux ψ_{A}, as shown in Expressions (4)-(5); L_{q} represents the q-axis inductance, is represents the α-axis stator current in the stationary αβ reference frame, i_{β} represents the β-axis stator current in the stationary αβ reference frame, ψ_{αr} represents the active α-axis rotor flux in the stationary αβ reference frame, and ψ_{βr} represents the active β-axis rotor flux in the stationary αβ reference frame.

S106, calculating the current rotor angle θ using an arctangent calculation method (the arctangent function) on the active rotor flux of expression (6).

In the above embodiment of the present invention, expression (4) is defines how to combine the voltage model (VM) and the current model (CM). It is a weighted fusion expression.

Expression (5) teaches how to transform expression (4) into a pair of useful filters (first-order low-pass and first-order high-pass) to reduce the number of parameters that need to be adjusted (by setting kᵢ to 0) when actually performing calculation.

After calculating the fused stator flux using expressions (4) or (5), it is converted into rotor flux using expression (6), which is responsible for subtracting the interference generated by the stator current (i_{q} of L_{q}).

Expression (5) is simplified into expression (4) by adjusting parameters, resulting in the stator total flux linkage ψ_{A}, which is then fed into expression (6).

Expression (6) is the “physical implementation” of all the previous calculation results. This relationship is reflected in the transformation “from observed value to physical value”.

Expressions (4) and (5) calculate the “observed”: They use control theory (filters) to calculate the total magnetic field induced by the motor stator windings. This magnetic field is greatly affected by the current and is “virtual,” so it cannot be directly used to calculate the rotor angle.

Expression (6) calculates the “essence”: It utilizes the physical characteristics of the motor (inductance L_{q}). That is: a portion of the result calculated by expressions (4) and (5) is the ‘false magnetic field’ generated by the current on the inductor, which is subtracted by expression (6).

Therefore, ψ_{α} and ψ_{β} on the right side of expression (6) are actually the results of the calculations in expressions (4) and (5). Without the preceding fusion calculation, expression (6) would have no input data; without the subtraction operation in expression (6), the preceding calculation results would not be able to be brought into a FOC (Field Oriented Control) loop.

In expressions (1) and (2), ψ_{α} and ψ_{β} represent “candidates.” Expression (1) calculates a set of ψ_{α}(VM) and ψ_{β} (VM), while expression (2) calculates a set of ψ_{α}(CM) and ψ_{β} (CM). These two sets of data are independent and may even conflict.

In expression (6), ψ_{α} and ψ_{β} represent the “winner.” They are the unique, optimized stator flux values (i.e., ψ_{A}) generated after the “candidates” in expressions (1) and (2) have been “filtered and fused” by expressions (4) and (5).

Therefore, ψ_{α} and ψ_{β} in expression (6) are actually the output of expression (4) or (5). Expression (6) uses the general symbols ψ_{α} and ψ_{β} for stator flux linkage for generality, but in the algorithm flow, it only becomes meaningful after the filter has finished running.

In this embodiment of the present invention, the current rotor angle is calculated using the sensorless hybrid observer. Since the sensorless hybrid observer of the present invention can quickly converge to a true value of the rotor angle θ, there is no need to specifically set an initial rotor angle to estimate (calculate) the current rotor angle θ.

The sensorless hybrid observer for an electric motor provided in this embodiment of the present invention, as shown in FIG. 2, can quickly converge to obtain a near-zero speed closed-loop in a very short time. The hybrid observer is in a strong convergence state, and the observed values are consistent with the true values. The observed electric motor angle (current rotor angle of the electric motor) θ calculated by the sensorless hybrid observer has a higher initial value while the true motor angle has an initial value near 1. The sensorless control system is given with a target speed value at the beginning of the first second, and after 10 ms, the observed rotor angle θ calculated by the sensorless observer quickly converges to the true rotor angle, obtaining the effect of rapid zero-speed closed loop.

In this embodiment of the present invention, the current acquisition module 12 can use a current sensor, such as a Hall Effect current sensor. The voltage acquisition module 13 can use a voltage sensor, such as a resistor divider or a dedicated voltage sensor. The controller 10 can use a digital signal processor (DSP) or a microcontroller unit (MCU), for example, TI's TMS320F28335 DSP features high-speed floating-point arithmetic capability and is suitable for processing complex flux calculation algorithms.

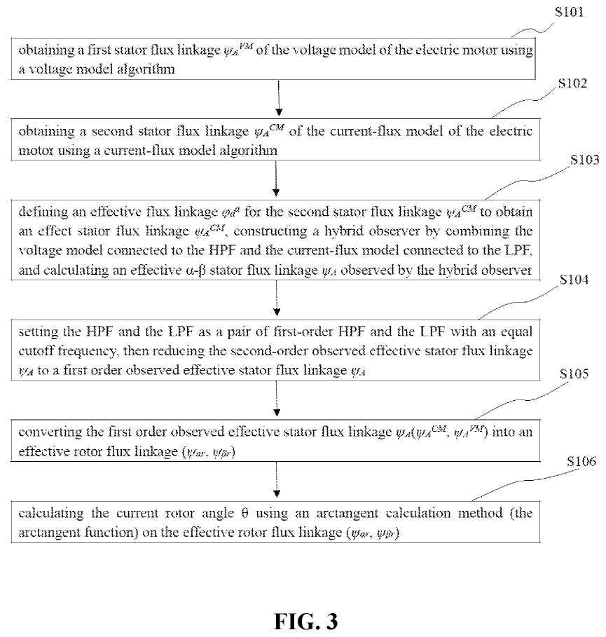

Please refer to FIG. 3, a sensorless control method for the electric motor provided in this embodiment of the present invention comprises the above-mentioned steps of S101 to S106 performed by the sensorless control system:
S101, obtaining a first stator flux

$${ψ}_{A}^{VM}$$

of the voltage model of the electric motor using a voltage-model algorithm;
S102, obtaining a second stator flux

$${ψ}_{A}^{CM}$$

of the current model of the electric motor using a current-model algorithm;
S103, defining an active flux φ_{d}^{a} for the second stator flux

$${ψ}_{A}^{CM}$$

to obtain an effect stator flux

$${ψ}_{A}^{CM} ,$$

constructing a hybrid observer by combining the voltage model connected to the HPF and the current model connected to the LPF, and calculating an active αβ-axis stator flux ψ_{A} observed by the hybrid observer;
S104, setting the HPF and the LPF as a pair of first-order HPF and the LPF with an equal cutoff frequency, then reducing the second-order observed active stator flux ψ_{A} to a first order observed active stator flux ψ_{A}:
S105, converting the first order observed active stator flux ψ_{A}

$${ψ}_{A} ( {ψ}_{A}^{CM} , {ψ}_{A}^{VM} )$$

into an active rotor flux (ψ_{αr}, ψ_{βr}); and
S106, calculating the current rotor angle θ using an arctangent calculation method (the arctangent function) on the active rotor flux (ψ_{αr}, ψ_{βr}).

At the step of S103, outputting the first stator flux of the voltage model to the HPF to obtain the filtered first stator flux

$${ψ}_{A}^{VM}$$

of the voltage model, outputting the second stator flux of the current model to the LPF to obtain the filtered second stator flux

$${ψ}_{A}^{CM}$$

AC of the current model, and substituting the active flux φ_{d}^{a} into the filtered second stator flux

$${ψ}_{A}^{CM}$$

to yield an active stator flux

$${ψ}_{A}^{CM} ,$$

summing the filtered first stator flux

$${ψ}_{A}^{VM}$$

and the active stator flux

$${ψ}_{A}^{CM}$$

to obtain the hybrid observer with the observed active αβ-axis stator flux; wherein set the cutoff frequencies of the LPF and the HPF equal.

In the present invention, for both non-salient pole motors (such as SPMSMs) and salient pole motors (such as IPMSMs), the concept of the active flux φ_{d}^{a} is introduced to solve the salient pole problem caused by the difference in magnetic permeability between permanent magnets and core materials. The definition of active stator flux φ_{d}^{a} simplifies the design of flux observers, making them applicable to various motor types. For non-salient pole motors, the d-axis and q-axis inductances are equal. For surface-mounted permanent magnet synchronous motors (SPMSM) and embedded permanent magnet synchronous motors (IPMSM), the concept of active stator flux φ_{d}^{a} is defined as shown in Expression (3).

An unmanned aerial vehicle (UAV) provided in the present invention includes the electric motor which includes the sensorless control system provided in the above-mentioned embodiments.

The electric motor-sensorless observer of this invention can operate over a wide speed range, and have a high precision and a strong robustness. It can converge rapidly in a very short time, supports near-zero speed closed-loop control, has wide applications, simple design, and eliminates the need to adjust the PI controller or sliding mode controller within the observer; only setting the filter cutoff frequency of the filters, avoiding the parameter setting process.

In the present invention, two models for flux calculation:
voltage model: flux is calculated by integrating the back electromotive force (EMF); however, at low speeds, the integration accuracy is insufficient due to the small amplitude of the back EMF, and it is significantly affected by inverter nonlinearity;
current model: flux is calculated based on motor parameters and current. It performs better than the voltage model at low speeds, but is significantly affected by parameter errors at high speeds.

### Design of a Hybrid Active Flux Observer:

combining the advantages of voltage and current models, a hybrid active flux observer was designed. A pair of low-pass and high-pass filters with equal cutoff frequencies are used to filter the fluxes of the voltage and current models, respectively. The filtered voltage flux and current flux are then summed to obtain the final α-β axis flux. This eliminates the need for conventional PI parameter tuning.

High-precision position estimation is achieved by calculating the rotor angle using the arctangent method.

The performance of the Hybrid Active flux Observer:
at low speeds, the current model dominates, improving observation accuracy and robustness; and
at high speeds, the voltage model dominates, ensuring the stability of the observer.

In the voltage model, the time derivative of the voltage flux is the back electromotive force (EMF). This means the back EMF is directly related to the voltage flux. However, at low speeds, when the back EMF amplitude is insufficient, the integration accuracy for calculating the back EMF is inadequate. Furthermore, due to inverter nonlinearity and other factors, there is an unavoidable error between the reference voltage and the actual voltage, which also affects the low-speed performance of the voltage model to some extent. The current model does not have these drawbacks, meaning it performs better than the voltage model at low speeds. Therefore, combine the two models to construct a new hybrid active flux observer. This observer balances the performance of the current model at low speeds and the stability of the voltage model at high speeds. A pair of low-pass and high-pass filters with equal cutoff frequencies are used to filter the fluxes of the voltage model and the current model, respectively. Further, introduce the active flux φ_{d}^{a} for non-salient pole motors (such as SPMSMs) and salient pole motors (such as IPMSMs), the concept of active flux is introduced to solve the salient pole problem caused by the difference in magnetic permeability between the permanent magnet and the core material. The definition of active flux simplifies the design of hybrid flux observer. For non-salient pole motors, the d-axis and q-axis inductances are equal. For the SPMSM) and the IPMSM, the concept of active flux is defined as shown in Expression (3).

Finally, the two filtered fluxes are summed to obtain the observed α-β axis flux. The current angle is then calculated using the arctangent method. The final result is shown in Figure d; the observer can converge rapidly in a very short time, achieving near-zero-speed closed-loop.

The above description is only a preferred embodiment of the present invention and is not intended to limit the present invention. Any modifications, equivalent substitutions and improvements made in the spirit and principles of the present invention should be included within the protection scope of the present invention.

What is claimed is:

1. A sensorless control system for an electric motor, comprising:
a current acquisition module, used for measuring stator currents of the electric motor in real time;
a voltage acquisition module, used for measuring stator voltages of the electric motor; and
a controller, comprising:
a voltage model, for obtaining a first stator flux
$${ψ}_{A}^{VM}$$
using a voltage-model algorithm based on an α-axis stator current i_{α}, a β-axis stator current i_{β}, an α-axis stator voltage V_{α}, a β-axis stator voltage V_{β} and a stator resistance Rs;
a current model, for defining a second stator flux
$${ψ}_{A}^{CM}$$
using a current-model algorithm based on a rotor angle θ, a d-axis inductance L_{d}, a q-axis inductance L_{q}, a d-axis current i_{d}, a q-axis current i_{q}, and a permanent magnet flux ψ_{f} generated by permanent magnets in the electric motor;
a low-pass filter (LPF), connected to the current-mode model and used for filtering the second stator flux
$${ψ}_{A}^{CM}$$
of the current-mode model;
a high-pass filter (HPF), connected to the voltage-mode model and used for filtering the first stator flux
$${ψ}_{A}^{VM}$$
of the voltage-mode model; and
a hybrid observer, which is constructed by combining the voltage model and the current model, and is used for estimating an active αβ-axis stator flux ψ_{A}, wherein a pair of the LPF and the HPF with equal cutoff frequencies are used to filter the first and second stator fluxes of the voltage model and the current model, respectively; the filtered first and second stator fluxes are summed to obtain the active αβ-axis stator flux ψ_{A};
wherein the controller performing steps of:
implementing the voltage-model algorithm and obtaining the first stator flux
$${ψ}_{A}^{VM}$$
of the voltage model;
implementing the current-model algorithm and obtaining the second stator flux
$${ψ}_{A}^{CM}$$
of the current model;
outputting
$${ψ}_{A}^{VM}$$
of the voltage model to the HPF for filtering, and outputting
$${ψ}_{A}^{CM}$$
of the current model to the LPF for filtering;
constructing the hybrid observer by combining a voltage-model output passed through the HPF and a current-flux-model output passed through the LPF, and estimating the active αβ-axis stator flux ψ_{A} of the hybrid observer using the filtered
$${ψ}_{A}^{VM}$$
and
$${ψ}_{A}^{CM} ;$$
converting the active αβ-axis stator flux ψ_{A} into an active rotor flux; and
estimating the rotor angle by applying an arctangent calculation to components of the active rotor flux.

2. The system of claim 1, wherein the voltage-model algorithm is Expression (1):
$$\{ \begin{matrix}ψ α = \int ( {V}_{α} - {i}_{α} {R}_{s} ) dt \\ ψ β = \int ( {V}_{β} - {i}_{β} {R}_{s} ) dt\end{matrix} \qquad ( 1 )$$
wherein ψ_{α} represents an α-axis stator flux of the voltage model in a stationary αβ reference frame, ψ_{β} represents a β-axis stator flux of the voltage model, and “t” represents time.

3. The system of claim 2, wherein the current-model algorithm is Expression (2):
$$[ \begin{matrix}{ψ}_{α} \\ {ψ}_{β}\end{matrix} ] = [ \begin{matrix}cos θ & - sin θ \\ sin θ & cos θ\end{matrix} ] \cdot [ \begin{matrix}{L}_{d} {i}_{d} + {ψ}_{f} \\ {L}_{q} {i}_{q}\end{matrix} ] \qquad ( 2 )$$
wherein ψ_{α} represents an α-axis stator flux of the current model in a stationary αβ reference frame, ψ_{β} represents a β-axis stator flux of the current model.

4. The system of claim 3, wherein the active αβ-axis stator flux ψ_{A} is estimated using Expression (4):
$${ψ}_{A} = \frac{{k}_{p} d + {k}_{i}}{{\underbrace{{s}^{2} + {k}_{p} s + {k}_{i}}}_{LPF}} {ψ}_{A}^{CM} + \frac{{s}^{2}}{{\underbrace{{s}^{2} + {k}_{p} s + {k}_{i}}}_{BPF}} {ψ}_{A}^{VM} \qquad ( 4 )$$
wherein, “s” represents a frequency in a Laplace transform domain, and kₚ and kᵢ are filter parameter that determine filtering characteristics and depend on the cutoff frequencies of the filters.

5. The system of claim 4, wherein, let kᵢ=0, the active αβ-axis stator flux ψ_{A} is expressed by Expression (5):
$${ψ}_{A} = \frac{{k}_{p}}{s + {k}_{p}} {ψ}_{A}^{CM} + \frac{s}{s + {k}_{p}} {ψ}_{A}^{VM} . \qquad ( 5 )$$

6. The system of claim 5, obtaining the active rotor flux using Expression (6):
$$[ \begin{matrix}{ψ}_{α r} \\ {ψ}_{β r}\end{matrix} ] = [ \begin{matrix}{ψ}_{α} \\ {ψ}_{β}\end{matrix} ] - [ \begin{matrix}{L}_{q} + {i}_{α} \\ {L}_{q} \times {i}_{β}\end{matrix} ] \qquad ( 6 )$$
wherein ψ_{αr} represents an active α-axis rotor flux in the stationary αβ reference frame, and ψ_{βr} represents an active β-axis rotor flux in the stationary αβ reference frame; ψ_{α} represents an α-axis stator flux calculated by expression (4) or (5), ψ_{β} represents a β-axis stator flux calculated by expression (4) or (5).

7. The system of claim 3, defining an active flux (pd of expression (3):
$$\begin{matrix}{ψ}_{d}^{a} = {φ}_{f} & for SPMSM ( {L}_{d} = {L}_{q} ) \\ {ψ}_{d}^{a} = {φ}_{f} + ( {L}_{d} - {L}_{q} ) {i}_{d} & for IPMSM ( {L}_{d} < {L}_{q} )\end{matrix} \qquad ( 3 )$$
wherein
$${φ}_{d}^{a}$$
is a total d-axis flux for ψ_{f} in the expression (2), when the expression (3) is applied for a surface permanent magnet synchronous motor (SPMSM),
$${φ}_{d}^{a}$$
is only determined by the permanent magnet flux ψ_{f} itself, when the expression (3) is applied for an interior permanent magnet synchronous motor (IPMSM), besides ψ_{f}, φ_{d}^{a} is also related to a modulation effect from a difference between L_{d} and L_{q} on i_{d}.

8. A sensorless control method for an electric motor, comprising steps of:
implementing a voltage-model algorithm and obtaining a first stator flux
$${ψ}_{A}^{VM}$$
of the voltage model;
implementing a current-model algorithm and obtaining a second stator flux
$${ψ}_{A}^{CM}$$
of the current model;
outputting
$${ψ}_{A}^{CM}$$
of the voltage model to a high-pass filter (HPF) for filtering, and outputting
$${ψ}_{A}^{CM}$$
of the current model to a low-pass filter (LPF) for filtering;
constructing a hybrid observer by combining a voltage-model output passed through the HPF and a current-flux-model output passed through the LPF, and estimating the active αβ-axis stator flux ψ_{A} of the hybrid observer using the filtered
$${ψ}_{A}^{VM}$$
and
$${ψ}_{A}^{CM} ;$$
converting the active αβ-axis stator flux ψ_{A} into an active rotor flux; and
estimating a current rotor angle by applying an arctangent calculation to components of the active rotor flux.

9. The method of claim 8, wherein the voltage-model algorithm is Expression (1):
$$\{ \begin{matrix}ψ α = \int ( {V}_{α} - {i}_{α} {R}_{s} ) dt \\ ψ α = \int ( {V}_{β} - {i}_{β} {R}_{s} ) dt\end{matrix} \qquad ( 1 )$$
wherein ψ_{α} represents an α-axis stator flux of the voltage model in a stationary αβ reference frame, ψ_{β} represents a β-axis stator flux of the voltage model, V_{α} represents an α-axis stator voltage of the electric motor, V_{β} represents a β-axis stator voltage of the electric motor, i_{α} represents an α-axis stator current of the electric motor, i_{β} represents a β-axis stator current of the electric motor, Rₛ represents a stator resistance, and “dt” denotes an integral over time.

10. The method of claim 9, wherein the current-model algorithm is Expression (2):
$$[ \begin{matrix}{ψ}_{α} \\ {ψ}_{β}\end{matrix} ] = [ \begin{matrix}cos θ & - sin θ \\ sin θ & cos θ\end{matrix} ] \cdot [ \begin{matrix}{L}_{d} {i}_{d} + {ψ}_{f} \\ {L}_{q} {i}_{q}\end{matrix} ] \qquad ( 2 )$$
wherein ψ_{α} represents an α-axis stator flux of the current model in a stationary αβ reference frame, ψβ represents a β-axis stator flux of the current model, θ is a rotor angle, L_{d} represents a d-axis inductance, L_{g} represents a q-axis inductance, i_{d} represents a d-axis current, i_{q} represents a q-axis current, and ψ_{f} represents a permanent magnet flux generated by permanent magnets in the electric motor.

11. The method of claim 10, wherein the active αβ-axis stator flux ψ_{A} is estimated using Expression (4):
$${ψ}_{A} = {\underbrace{\frac{{k}_{p} s + {k}_{1}}{{s}^{2} + {k}_{p} s + {k}_{1}}}}_{LPF} {ψ}_{A}^{CM} + {\underbrace{\frac{{s}^{2}}{{s}^{2} + {k}_{p} s + {k}_{1}}}}_{HPF} {ψ}_{A}^{VM} \qquad ( 4 )$$
wherein, “s” represents a frequency in the Laplace transform domain; kₚ and kᵢ are filter parameters that determine filtering characteristics and depend on cutoff frequencies of the filters,
$${ψ}_{A}^{VM}$$
denotes the first stator flux passed through the HPF,
$${ψ}_{A}^{CM}$$
denotes the second stator flux passed through the LPF, and filtered outputs
$${ψ}_{A}^{VM}$$
and
$${ψ}_{A}^{CM}$$
are summed to yield the active α-β stator flux ψA along the α- and β-axes in the stationary αβ reference frame.

12. The method of claim 11, wherein, let kᵢ=0, the active αβ-axis stator flux ψ_{A} is expressed by Expression (5):
$${ψ}_{A} = \frac{{k}_{p}}{s + {k}_{p}} {ψ}_{A}^{CM} + \frac{s}{s + {k}_{p}} {ψ}_{A}^{VM} \qquad ( 5 )$$
wherein the HPF and the LPF is provided with an equal cutoff frequency.

13. The method of claim 12, obtaining the active rotor flux using Expression (6):
$$[ \begin{matrix}{ψ}_{α r} \\ {ψ}_{β r}\end{matrix} ] = [ \begin{matrix}{ψ}_{α} \\ {ψ}_{β}\end{matrix} ] - [ \begin{matrix}{L}_{q} \times {i}_{α} \\ {L}_{q} \times {i}_{β}\end{matrix} ] \qquad ( 6 )$$
wherein ψ_{αr} represents an active α-axis rotor flux in the stationary αβ reference frame, and ψ_{βr} represents an active β-axis rotor flux in the stationary αβ reference frame; ψ_{α} represents an α-axis stator flux calculated by expression (4) or (5), ψ_{β} represents a β-axis stator flux calculated by expression (4) or (5).

14. The method of claim 10, defining an active flux φ_{d}^{a} of expression (3):
$$\begin{matrix}{φ}_{d}^{a} = {φ}_{f} & for SPMSM ( {L}_{d} = {L}_{q} )\end{matrix} \qquad ( 3 )$$
$${φ}_{d}^{a} = {φ}_{f} + ( {L}_{d} - {L}_{q} ) {i}_{d} \qquad for IPMSM ( {L}_{d} < {L}_{q} )$$
wherein
$${φ}_{d}^{a}$$
is a total d-axis flux for ψ_{f} in the expression (2), when the expression (3) is applied for a surface permanent magnet synchronous motor (SPMSM),
$${φ}_{d}^{a}$$
is only determined by the permanent magnet flux ψ_{f} itself, when the expression (3) is applied for an interior permanent magnet synchronous motor (IPMSM), besides ψ_{f}, φ_{d}^{a} is also related to a modulation effect from a difference between L_{d} and L_{q} on i_{d}.
